(19) United States
(12) Patent Application Publication
(10) Pub. No.: US 2026/0141019 A1
(43) Pub. Date: May 21, 2026

(54) SYSTEMS AND METHODS FOR EFFICIENTLY SOLVING LARGE AND SPARSE CONVEX OPTIMIZATION PROBLEMS ON HIGHLY PARALLEL PROCESSING HARDWARE

(71) Applicant: Kinaxis Inc., Ottawa (CA)

(72) Inventor: Dane HENSHALL, Kemptville (CA)

(73) Assignee: Kinaxis Inc., Ottawa, ON (CA)

(21) Appl. No.: 19/392,395

(22) Filed: Nov. 18, 2025

Related U.S. Application Data
(60) Provisional application No. 63/722,890, filed on Nov. 20, 2024.

(51) Int. Cl. G06F 17/11

(52) U.S. Cl. CPC G06F 17/11

(57) ABSTRACT

Systems, methods, and computer-readable media for solving large, sparse convex optimization problems on highly parallel hardware. A computing apparatus receives an initial point and iteratively updates an optimization point via a first subsystem that constructs and updates a Karush-Kuhn-Tucker (KKT) system and applies small steps in an improving direction. In parallel, a second subsystem incrementally solves the updated KKT system, while a third subsystem optimizes parameters such as preconditioners and matrix permutations. Outputs are exchanged among subsystems during each iteration to enable continuous refinement. A small-step criterion, enforced via line search or trust-region procedures, ensures convergence. Execution leverages GPUs or TPUs to partition and process KKT systems concurrently, dynamically adjusting step size based on convergence indicators.

This application claims priority to U.S. Provisional Patent Application 63/720,890 filed on Nov. 20, 2024, which is incorporated herein in its entirety, by reference.

### BACKGROUND

Mathematical programming is a technique for making complex decisions by modelling an abstraction of a problem as a collection of mathematical constraints, variables, and objectives and using computer-based systems (called “solvers”) to compute good solutions.

There are a number of standard categories of mathematical programs that are used to describe what types of constraints, variables, and objectives are used by a model, or supported by a solver. In mathematical programming hierarchy, the simplest form of mathematical program is a “Linear Program”. Linear Programs have continuous variables, a linear objective function, and constraints which are either affine or linear inequalities, an example of which is shown as follows: find the minimum of x₁, subject to the following constraints

$${x}_{1} + 3 {x}_{2} \leq - 4 , and 2 {x}_{1} + {x}_{2} \leq - 2 ; for {x}_{1} , {x}_{2} ∈ ℝ$$

If the variables are constrained to integers, Linear Programming (LP) is categorized as Integer Programming (IP). Where there is a mixture of integer and continuous variables, the programming is categorized as Mixed Integer Programming (MIP)/Mixed Integer Linear Programming (MILP).

On the other hand, if quadratic terms are allowed in the objective function, LP is categorized as Quadratic Programming (QP), and further, as Quadratic Constraint Programming (QCP) when quadratic constraints are allowed.

Finally, where there is a mixture of integer and continuous variables, along with quadratic terms in the objective function and quadratic constraints, the mathematical programming is termed as Mixed integer Quadratic Constrained Programming (MIQCP).

There has been a considerable amount of research and development performed on how to efficiently solve linear programs since the technique was formulated in the mid-20th century. The majority of Linear Programming solvers use either a variation of a first-order Simplex algorithm or a variation of a second-order Interior Point method (commonly referred to as the “barrier” algorithm due to its use of a logarithmic barrier function). The term first and second order refers to whether or not the algorithm uses information from a first-order derivative or a second-order derivative of an objective function.

Traditional Interior Point Methods are laborious and resource-intensive. There is not only a need to develop a novel Interior Point Method, but also a need for a computer-implemented method that can execute the newly-developed Interior Point method in a manner that is efficient and less resource-intensive.

### BRIEF SUMMARY

Disclosed herein are systems and methods that comprise a novel Interior Point Method algorithm, which are designed for execution using one or more Central Processing Units (CPUs) with one or more accelerated computing co-processors. Examples of accelerated computing co-processors include a Graphics Processing Unit (GPU) and a Tensor Processing Unit (TPU). Traditionally, GPUs have been used in the domain of graphics-related jobs, such as gaming, videos, photos, graphics, video editing and visual effects. Similarly, TPUs have traditionally used for convolutional neural network machine learning applications.

Disclosed herein are systems and methods that provide a GPU-accelerated or a TPU-accelerated LP and MIP solver by developing novel algorithms that are able to take full advantage of the power of a GPU-based or a TPU-based platform. Examples of such a platform include: a plurality of CPU cores working in tandem with a plurality of GPU cores; or a plurality of CPU cores working in tandem with a plurality of TPU cores

Disclosed herein are systems and method that provide a very fast iterative solver for systems of linear equations specifically designed for when the system of linear equations is represented as a chain of complex linear operations.

In one aspect, a computing apparatus is provided, that includes a processor. The computing apparatus also includes a memory storing instructions that, when executed by the processor, configure the apparatus to: (a) receive an initial point for the convex optimization problem; and (b) iteratively update an optimization point, by a first iterative subsystem, by: first constructing and then updating a Karush-Kuhn-Tucker (KKT) system based on a current point, thereby producing an updated KKT system; and taking a step in an improving direction. The apparatus is also configured to: (c) in parallel with step (b): compute the improving direction, by a second iterative subsystem, by incrementally solving the updated KKT system using one or more direct or iterative methods; and optimize, by a third iterative subsystem, one or more parameters for direction computation. The apparatus is also configured to: (d) exchange outputs among the parallel iterative subsystems during each iteration, where: the updated KKT system is provided to compute the improving direction, the improving direction is provided to update the optimization point, an incremental solution of the KKT system is provided to optimize the parameters, and optimized parameters are provided to compute the improving direction. The apparatus is also configured to: (e) apply a small-step criterion to determine a step size that satisfies a predefined bound on a norm of the update direction. The apparatus is also configured to: (f) continue iterative updates until one or more convergence criteria are satisfied. The apparatus is also configured to: (g) output an optimal or near-optimal solution to the convex optimization problem.

The computing apparatus may also include where the one or more parameters include at least one of a preconditioner, a matrix permutation, or algorithm meta-parameters.

The computing apparatus may also include where the small-step criterion is enforced by a line search or trust-region procedure that ensures monotonic decrease in an objective or merit function. The computing apparatus may also include where the predefined bound is dynamically adjusted based on one or more convergence indicators include at least one of: residual norm of the KKT system, primal-dual gap, or condition number of the system matrix. The computing apparatus may also include where the small-step criterion is applied in parallel with parameter optimization, such that the step size and preconditioner parameters are jointly tuned to improve convergence.

The computing apparatus may also include where the iterative subsystems are executed on one or more graphics processing units (GPUs) or one or more tensor processing units (TPUs) configured to perform parallel matrix operations for solving the KKT system. The computing apparatus may also include where the small-step criterion is enforced using GPU or TPU kernels that dynamically adjust step size based on convergence indicators computed in parallel. The computing apparatus may also include where the GPU or TPU execution includes partition the KKT system into blocks and distributing the blocks across multiple processing cores for concurrent computation of the improving direction. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: (a) receive an initial point for the convex optimization problem; and (b) iteratively update an optimization point, by a first iterative subsystem, by: first construct and then updating a Karush-Kuhn-Tucker (KKT) system based on a current point, thereby producing an updated KKT system, and take a step in an improving direction. The computer is also configured to: (c) in parallel with step (b): compute the improving direction, by a second iterative subsystem, by incrementally solving the updated KKT system using one or more direct or iterative methods; and optimize, by a third iterative subsystem, one or more parameters for direction computation. The computer is also configured to: (d) exchange outputs among the parallel iterative subsystems during each iteration, where: the updated KKT system is provided to second iterative subsystem compute the improving direction; the improving direction is provided to the first iterative subsystem update the optimization point; an incremental solution of the KKT system is provided to the third iterative subsystem optimize the parameters; and optimized parameters are provided to the first iterative subsystem compute the improving direction. The computer is also configured to: (e) apply a small-step criterion to determine a step size that satisfies a predefined bound on a norm of the update direction. The computer is also configured to: (f) continue iterative updates until one or more convergence criteria are satisfied. The computer is also configured to: (g) output an optimal or near-optimal solution to the convex optimization problem.

The non-transitory computer-readable storage medium may also include where the one or more parameters include at least one of a preconditioner, a matrix permutation, or algorithm meta-parameters.

The non-transitory computer-readable storage medium may also include where the small-step criterion is enforced by a line search or trust-region procedure that ensures monotonic decrease in an objective or merit function. The non-transitory computer-readable storage medium may also include where the predefined bound is dynamically adjusted based on one or more convergence indicators include at least one of: residual norm of the KKT system, primal-dual gap, or condition number of the system matrix. The non-transitory computer-readable storage medium may also include where the small-step criterion is applied in parallel with parameter optimization, such that the step size and preconditioner parameters are jointly tuned to improve convergence.

The non-transitory computer-readable storage medium may also include where the iterative subsystems are executed on one or more graphics processing units (GPUs) or one or more tensor processing units (TPUs) configured to perform parallel matrix operations for solving the KKT system. The non-transitory computer-readable storage medium may also include where the small-step criterion is enforced using GPU or TPU kernels that dynamically adjust step size based on convergence indicators computed in parallel. The non-transitory computer-readable storage medium may also include where the GPU or TPU execution includes partition the KKT system into blocks and distributing the blocks across multiple processing cores for concurrent computation of the improving direction. Other technical features may be readily apparent to one skilled in the art from the following figures, descriptions, and claims.

In one aspect, a computer-implemented method for solving a convex optimization problem using parallel iterative subsystems is provided. The method includes: (a) receiving an initial point for the convex optimization problem; and (b) iteratively updating an optimization point, by a first iterative subsystem, by: first constructing and then updating a Karush-Kuhn-Tucker (KKT) system based on a current point, thereby producing an updated KKT system, and taking a step in an improving direction. The computer-implemented method also includes: (c) in parallel with step (b): computing the improving direction, by a second iterative subsystem, by incrementally solving the updated KKT system using one or more direct or iterative methods; and optimizing, by a third iterative subsystem, one or more parameters for direction computation. The computer-implemented method also includes: (d) exchanging outputs among the parallel iterative subsystems during each iteration, where: the updated KKT system is provided to second iterative subsystem computing the improving direction; the improving direction is provided to the first iterative subsystem updating the optimization point; an incremental solution of the KKT system is provided to the third iterative subsystem optimizing the parameters; and optimized parameters are provided to the first iterative subsystem computing the improving direction. The computer-implemented method also includes: (e) applying a small-step criterion to determine a step size that satisfies a predefined bound on a norm of the update direction. The computer-implemented method also includes: (f) continuing iterative updates until one or more convergence criteria are satisfied. The computer-implemented method also includes: (g) outputting an optimal or near-optimal solution to the convex optimization problem.

The computer-implemented method may also include where the one or more parameters include at least one of a preconditioner, a matrix permutation, or algorithm meta-parameters.

The computer-implemented method may also include where the small-step criterion is enforced by a line search or trust-region procedure that ensures monotonic decrease in an objective or merit function. The computer-implemented method may also include where the predefined bound is dynamically adjusted based on one or more convergence indicators including at least one of: residual norm of the KKT system, primal-dual gap, or condition number of the system matrix. The computer-implemented method may also include where the small-step criterion is applied in parallel with parameter optimization, such that the step size and preconditioner parameters are jointly tuned to improve convergence.

The computer-implemented method may also include where the iterative subsystems are executed on one or more graphics processing units (GPUs) or one or more tensor processing units (TPUs) configured to perform parallel matrix operations for solving the KKT system. The computer-implemented method may also include where the small-step criterion is enforced using GPU or TPU kernels that dynamically adjust step size based on convergence indicators computed in parallel. The computer-implemented method may also include where the GPU or TPU execution includes partitioning the KKT system into blocks and distributing the blocks across multiple processing cores for concurrent computation of the improving direction. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for efficient execution of fused sparse linear operations on highly-parallel processing hardware in accordance with one embodiment.

FIG. 2 illustrates a block diagram of an iterative solve in accordance with one embodiment.

FIG. 3 illustrates representation of a computation as a linear operation graph in accordance with one embodiment.

FIG. 4 illustrates an aspect of the subject matter in accordance with one embodiment.

FIG. 5 illustrates transformation of an operational graph in accordance with one embodiment.

FIG. 6 illustrates a block diagram for constructing and executing Linear Operation Graphs in accordance with one embodiment.

FIG. 7 illustrates a block diagram for solving a convex optimization problem using parallel iterative subsystems. in accordance with one embodiment.

FIG. 8 illustrates a block diagram for solving a convex optimization problem using parallel iterative subsystems. in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM) or Flash memory, a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a GPU or a TPU.

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, Electrically Erasable Programmable Read-Only Memory, and flash memory devices); CD-ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

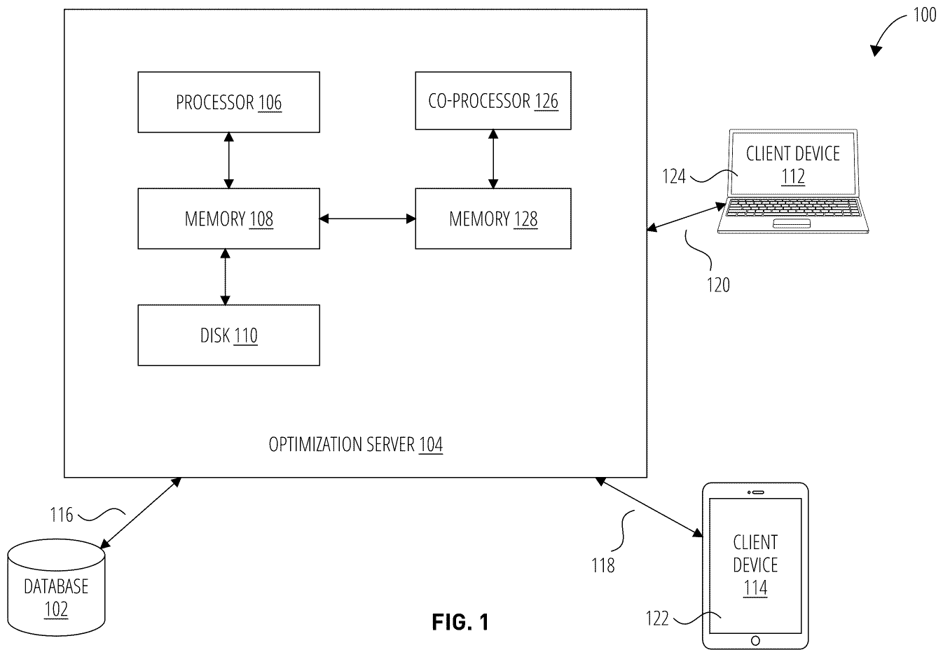

FIG. 1 illustrates an example of a system 100 for efficient execution of fused sparse linear operations on highly-parallel processing hardware.

System 100 includes an optimization server 104, a database 102, and client devices 112 and 114. Optimization server 104 can include one or more processors 106, a memory 108 associated with one or more processors 106, a disk 110, one or more co-processors 126 and a memory 128 associate with one or more co-processors 126. The one or more processors 106 interact with the one or more co-processors 126 via their respective memories 108 and 128. In some embodiments, memory 108 can be copied over to memory 128; calculations can be executed; and then memory 128 gets copied back to memory 108. In some embodiments, memory 108 can be volatile memory, compared with disk 110 which can be non-volatile memory. In some embodiments, similarly, memory 128 can be volatile memory, compared with disk 110 which can be non-volatile memory. In some embodiments, optimization server 104 can communicate with database 102 using interface 116. Database 102 can be a versioned database or a database that does not support versioning. While database 102 is illustrated as separate from optimization server 104, database 102 can also be integrated into optimization server 104, either as a separate component within optimization server 104, or as part of at least one of memory 108, memory 128 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108, memory 128 and disk 110. Storage media can include volatile and nonvolatile, removable and non-removable media implemented in any method or technology for storage of information such as computer-readable instructions, data structures, program modules or other data. Memory 108, memory 128 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVDs), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, optimization server 104 can communicate with database 102 using interface 116. Optimization server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow optimization server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LANs), Wireless Local area networks (WLANs), wide area networks (WANs) such as the Internet, serial, and universal serial bus (USB). The various network types to which interfaces 116, 118 and 120 can connect can run a plurality of network protocols including, but not limited to Transmission Control Protocol (TCP), Internet Protocol, real-time transport protocol (RTP), realtime transport control protocol (RTCP), file transfer protocol (FTP), and hypertext transfer protocol (HTTP).

Using interface 116, optimization server 104 can retrieve data from database 102. The retrieved data can be saved in disk 110, memory 108 or memory 128. In some cases, optimization server 104 can also comprise a web server, and can format resources into a format suitable to be displayed on a web browser. Optimization server 104 can then send requested data to client devices 112 and 114 via interfaces 120 and 118, respectively, to be displayed on applications 122 and 124. Applications 122 and 124 can be a web browser or other application running on client devices 112 and 114.

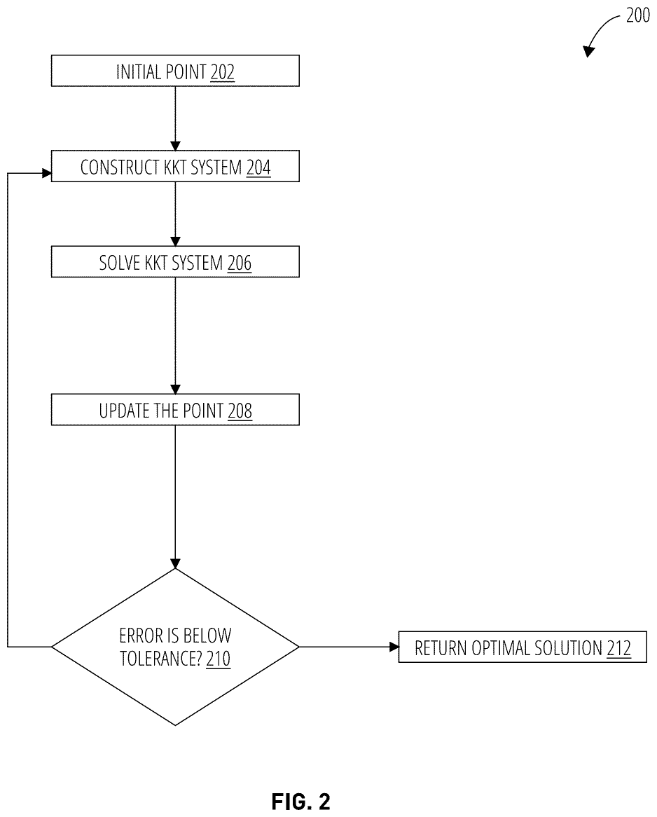

FIG. 2 illustrates a block diagram 200 of an iterative solve in accordance with one embodiment. An Interior Point method, also commonly referred to as a “central path following method”, solves a Linear Program by choosing a non-optimal starting point and iteratively improving that starting point until it is considered to be “good enough”. Each iteration takes the current point, constructs an approximation of the Linear Program around that point which can be optimized by solving an unconstrained system of linear equations, often called the Karush-Kuhn-Tucker (KKT) System, and improves the point by finding an optimal or near-optimal solution to the approximation. In practice it is often designed so that it takes between 20 and 200 iterations to reach a solution that is considered optimal by the standard 1e-6 absolute tolerance threshold.

This is illustrated in block diagram 200 in FIG. 2, which is described as follows. An initial “guess” to the Linear Program, or initial starting point is input at block 202. A KKT system, which is an approximation of the Linear Program, can be constructed at block 204. The KKT system can then be solved at block 206, which results in a new point, or updated point, at block 208. The new point can be thought of as a direction to move in, towards an optimal solution.

During the first iteration, the updated point (obtained at block 208) is compared with the initial point (from block 202), and one or more metrics (that compare the “distance” between the two points) is evaluated at decision block 210. If the difference, or error, is less than a pre-defined tolerance at decision block 210, then the iteration ceases, and the optimal solution (which is the updated point) is provided at block 212. If, on the other hand, the error is above the pre-defined tolerance, then the process returns to block 204 where a KKT system is constructed around the updated point, and the loop block 204—decision block 210 is repeated until the different between an input point (prior to block 204) and the updated point (at block 208) is below a tolerance (decision block 210), resulting in an optimal solution at block 212. The one or more metrics can be selected from at least one of: an absolute feasibility tolerance and an optimality tolerance. In some embodiments, these two tolerance tests are used together.

With regards to a tolerance criteria shown at decision block 210, there are a number of approaches that can be used. For example, there can be a first upper limit for an absolute error and a second upper limit for a relative objective gap. Each of these is defined as follows.

First, for the absolute error, the absolute error of a constraint for a given solution is the magnitude by which the constraint is violated. For example, the constraint “x1+x2=10”, with a solution of “x1=5, x2=5.1” would evaluate to “10.1=10” and have an absolute error of 0.1.

For the relative objective gap, let “pobj” be the primal objective value of a solution, and let “dobj” be the dual objective value of the solution. Then the absolute objective gap of the solution is defined as |pobj−dobj|. The relative objective gap of a solution can be generally defined as |pobj−dobj|/(|pobj+1e-6).

Under the above definitions, an example an example of a tolerance criteria can be: (Absolute error is less than 1e-6) and (relative objective gap is less than 1e-4).

### Systems and Methods for Efficient Execution of Fused Sparse Linear Operations on Highly-Parallel Processing Hardware

Disclosed herein is a very fast iterative solver for systems of linear equations designed for a system of linear equations that is represented as a chain of complex linear operations. While the solver, in one embodiment, is shown for chained linear operations, in general, the solver can be applied to any pair of operations that are associative, commutative, and distributive.

For example, the system and methods disclosed herein use an iterative technique based on a variant of “Basis Preconditioned Conjugate Residual” implemented for standard CPU systems in the MITR licensed HIGHS open source project. With this approach, the bulk of the processing time of each iteration is in computing the following chain of linear operations for triangular matrices U,L and the non-triangular matrix N, and input vector x (T subscript denotes transpose):

$$y = {U}_{T}^{- 1} {L}_{T}^{- 1} {N}_{T} {NL}^{- 1} {U}^{- 1} x$$

This chain of six linear operations can be represented as a single linear operation graph, which is then iteratively transformed in order to parallel it as effectively as possible.

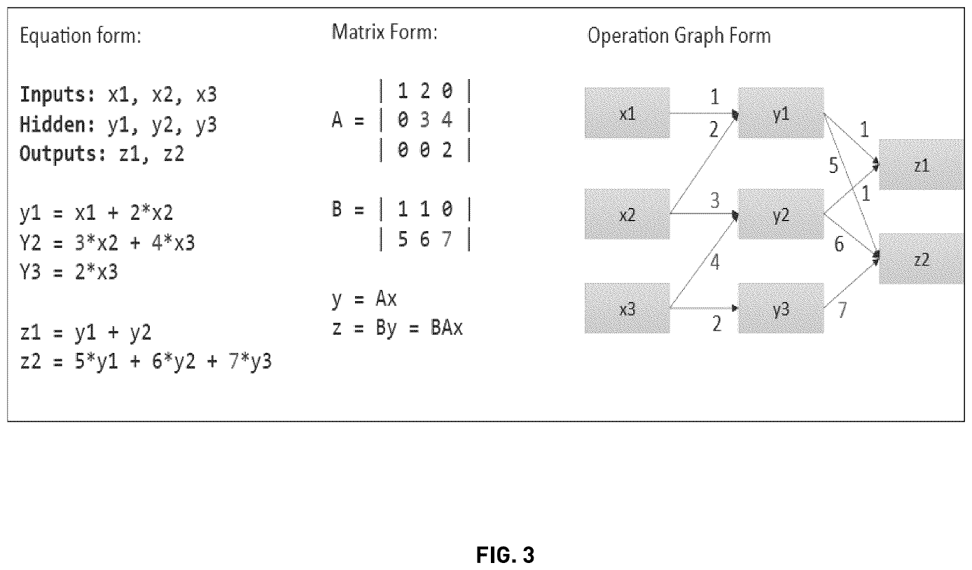

Consider the example shown in FIG. 3, where the two matrix-vector multiplications are chained. By representing the computation as a linear operation graph, it can be optimized for repeated executions by doing transformations on the operation graph which preserve the output. A “linear operation graph” is effectively the same as a neural network, except with a purely linear activation function. In other words the value of a node is the weighted sum of the value of its input nodes.

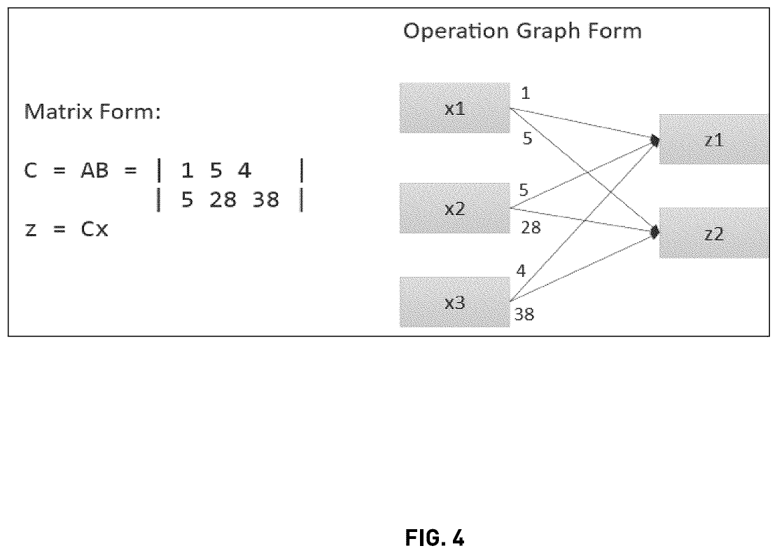

For example, something that may be commonly done today in libraries that use matrix operations is the matrices A and B may be multiplied together so that there is only one Matrix-vector operation, as shown in FIG. 4.

This can be accomplished by a series of transformations on the operation graph, or as a matrix multiplication. Consider the following example, which illustrates the value of this approach by demonstrating an operation on the linear graph that cannot be done when working with matrices directly.

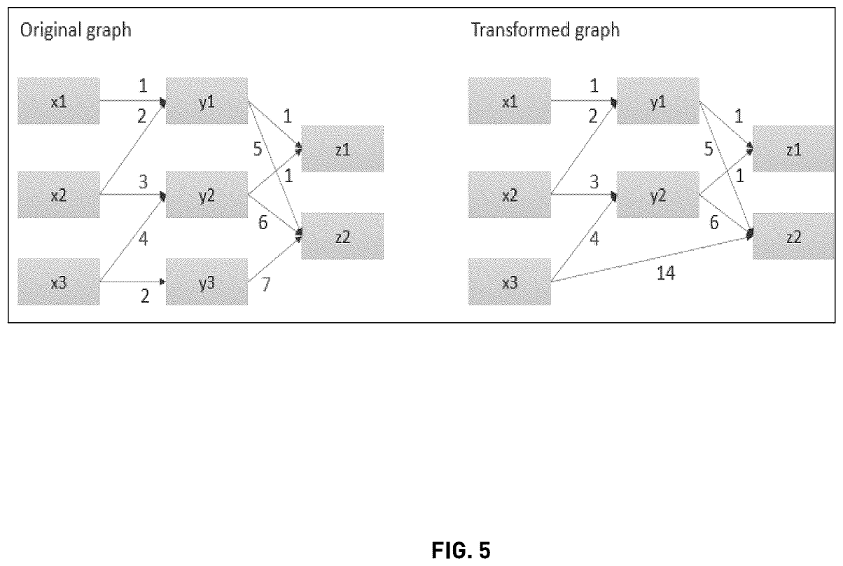

The y3 node in the original operation graph has only one input and one output, which allows for its removal while preserving the output, as shown in FIG. 5.

This simple operation reduces the total number of multiplications needed to compute the result by 1, and doesn't have a straight-forward matrix analogy. By viewing the chained linear operations as an operation graph instead of separate operations, optimizations such as this can be executed at a very granular level.

This is meaningful for operations that involve matrices which are mostly sparse with a few dense rows and columns. Multiplying these matrices together greatly increases the total number of operations due to the zero fill-in that results from matrix multiplication, but leaving it as two separate matrices prevents us from applying transformations that cross matrix boundaries to the vast majority of rows and columns which are sparse.

One transformation is particularly important, which is the concept of “flattening”. The biggest barrier to efficiently running the above y=U_{T}⁻¹ L_{T}⁻¹ N_{T} N L⁻¹ U⁻¹ x operation on highly parallel hardware is that the multiplication with an inverse operation is actually implemented as backwards and forwards substitution which leads to a sections of the operation graph which are very wide and thin.

Through a series of flattening transformations, the width of the graph can be significantly reduced, while the height of the graph is increased. This leads to a much more GPU-friendly or TPU-friendly computation that parallels well, even though on the surface, the traditional perspective of this operation is that it cannot be efficiently paralleled.

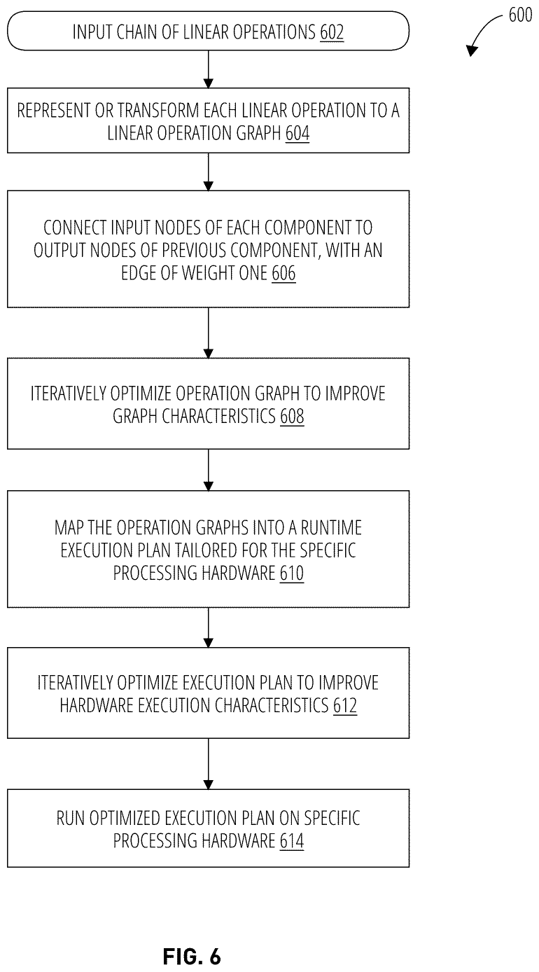

FIG. 6 illustrates a block diagram 600 for constructing and executing Linear Operation Graphs in accordance with one embodiment.

At 602, a chain of linear operations is taken as input. Next, at block 604, each linear operation in the chain is represented or transformed to a linear operation graph. At block 606, for each component in the chain (except the first component), connect input nodes of each component to output nodes of previous component, with an edge of weight one. Next, at block 608, iteratively optimize operation graph to improve graph characteristics. Such graph characteristics can include topological depth, memory footprint, or numerical accuracy. Next, at block 610, map the operation graphs into a runtime execution plan that is tailored for the specific processing hardware. For example, this can include flattening to take advantage of memory bandwidth. At block 612, iteratively optimize the execution plan to improve hardware execution characteristics. Examples of specific execution characteristics can include runtime, cache hierarchy utilization, or locality of memory accesses. For example, recording operations to minimize L2 cache misses. Finally, at block 614, run the optimized execution plan on the specific processing hardware.

A few nuances/variations to this method can include the following.

Whenever possible, the transformations applied to optimize the operation graph or the execution plan must themselves be linear operations to allow for the engine to be used to efficiently process updates to the input operations.

When this system is used to optimize an external iterative process, the external iterative process should start executing immediately using an unoptimized runtime plan. The optimizing of the operation graph and runtime plan should proceed in parallel to the external iterative process and updates passed to the external iterative process whenever it is beneficial to do so.

This is not just for linear operations, but any operations that have similar commutativity/associativity/distributivity properties.

An op graph may have multiple execution plans, for example for different precisions of floating points (e.g. bf16, tf32, and float32 may all have different execution plans optimized in different ways)

It is possible to efficiently update a runtime plan when the input parameters are changed in a way that preserves the structure.

### Systems and Methods for Efficiently Solving Large and Sparse Convex Optimization Problems on Highly Parallel Processing Hardware

When solving very large and sparse convex optimization problems, one of the most successful techniques has been Interior Point methods, which have been described above (see, for example, FIG. 2). These methods involve taking tens or hundreds of steps towards an optimal solution, where each step requires solving a large system of linear equations known as a KKT system. The runtime of Interior Point methods is usually dominated by the time it takes to solve the system of equations for each step.

Efficient algorithms that solve these systems of linear equations can be roughly divided into three categories:
1. Batch solve, where a valid solution is only obtained after a large computation is complete.
2. Iterative solve, where a solution is iteratively improved until it reaches a given quality threshold.
3. Hybrid solve, where a smaller batch computation is done before an iterative solve to reduce then number of iterations required.

For large and sparse optimization models, batch algorithms such as variants of Cholesky factorization can take a long time due to several factors. In particular, the KKT system may be dense, even if the model is sparse; or, the factors may be dense, even if the KKT system is sparse.

Large and dense matrices often lead to unacceptable memory or compute time requirements. As such, a number of techniques have been developed that are able to handle these cases. However, these techniques usually require the model to have some special structure that can be exploited. This makes it difficult to apply such techniques in a general purpose solver as it requires implementing and maintaining a large number of approaches to cover a wide enough number of cases.

Iterative methods can cope better with very large and sparse models since they have a smaller memory footprint. However, these usually require an expensive to compute “pre-conditioner” matrix in order to converge to a solution within a reasonable number of iterations. Just as in the batch case, preconditioners usually have to take advantage of some special structure in the model to be effective. General purpose pre-conditioners such as incomplete Cholesky factorizations are often not effective in practice against a wide variety of models.

Systems and methods disclosed herein, can efficiently solve large and sparse convex optimization problems on highly parallel processing hardware, by leveraging the following:

Iterative methods for inner solve usually start by converging rapidly, but the preconditioner becomes less effective as the iteration count increases.

With modern GPU systems, the core iteration logic can only make effective use of a small fraction of the overall compute power (15%-20%).

Effective preconditioners can be computed using iterative optimization.

By modifying the Interior Point method disclosed in FIG. 2-FIG. 6, to do a large number of small steps, there is a constant reset to the early phase where these methods exhibit good convergence. By making sure to only take small steps, the following can be achieved: optimization of the preconditioner; update the KKT system; take a step, and compute the optimal next step continuously and concurrently to one another.

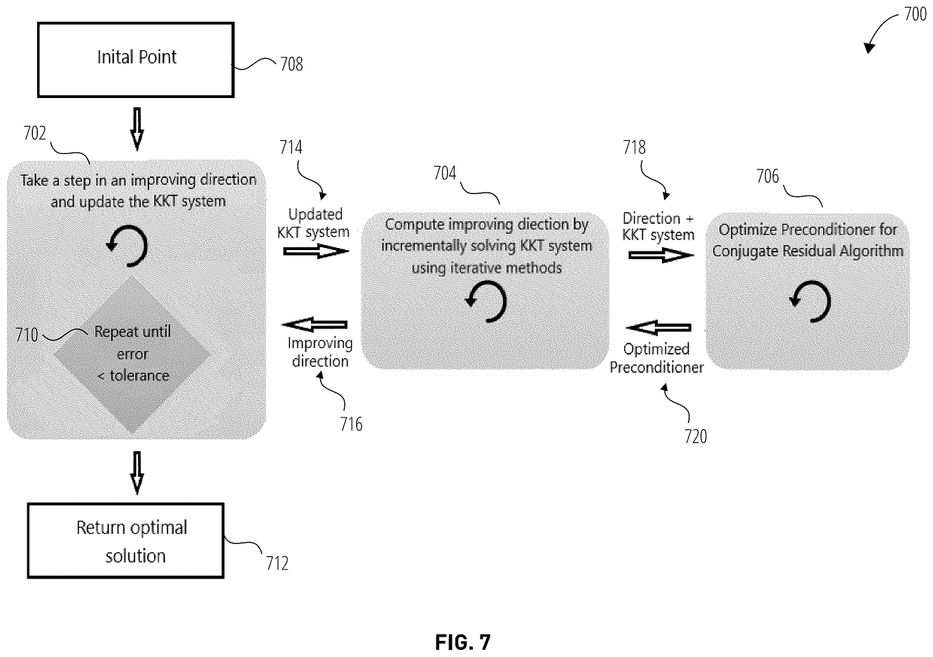

FIG. 7 illustrates a block diagram 700 for solving a convex optimization problem using parallel iterative subsystems. in accordance with one embodiment. FIG. 7 is a variation of the process illustrated in FIG. 2, by providing an alternate parallel approach. Instead of having one core loop illustrated in FIG. 2, there are three separate core loops, 702, 704 and 706, that are all interacting with each other, as shown by outputs/inputs 714, 716, 718 and 720. FIG. 7 illustrates a way to solve a KKT system in an iterative fashion while simultaneously updating that system. Each of the blocks 702, 704 and 706 represent an iterative sub-system. The circular arrow in each block visually represents the iterative nature of the subsystem. The sub-systems, as represented by blocks 702, 704 and 706, process in parallel. On each iteration, each of the blocks 702, 704 and 706 publish their respective outputs and read the respective latest inputs, as shown by outputs/inputs 714, 716, 718 and 720.

For example, at block 702, the sub-system takes as initial input, an initial point 708. Following input of the initial point 708, at block 702, the sub-system takes as input, a step in an improving direction, while it outputs an update of the KKT system, during an iteration. The sub-system at block 702 that refers to “take a step”, is equivalent to updating the point (with reference to FIG. 2, block 208). In fact, the sub-system at block 702 merges the two disparate blocks of constructing a KKT system (block 204 in FIG. 2) and updating a point (block 208 in FIG. 2) into one. In addition, the sub-system at block 702 evaluates one or more metrics between the updated point and an input point at decision block 710. If the one or more metrics are below a respective tolerance, then the updated point is the optimal solution, and it is returned at block 712. If, on the other hand, each of the respective tolerances is not met, the sub-system at block 702 interacts with the sub-systems at block 704 and 706.

In parallel, the sub-system at block 704 computes improving direction by incrementally solving the updated KKT system using direct and iterative methods. The sub-system at block 704 has two sets of input: an updated KKT system (output 714 from the sub-system at block 702), and an optimized preconditioner (output 720 from the sub-system at block 706). Furthermore, the sub-system at block 704 has two sets of output: an improving direction 716 (which serves as input for the sub-system at block 702), and a direction with an incremental solution of the KKT system 718 (which serves as an input for the sub-system at block 706).

In parallel, the system at block 706 optimizes the preconditioner for a conjugate residual algorithm. The sub-system at block 706 takes as input, a direction with an incremental solution of the KKT system 718 (which serves as an output for the sub-system at block 704), while it outputs an optimized preconditioner 720 (which serves as an input for the sub-system at block 704), during an iteration. The preconditioner is optimized for a conjugate residual algorithm.

Inherent in the process illustrated in FIG. 7 is the premise that the step taken in improving the direction is small, in that if too big a step is taken by the sub-system at block 702, then the work performed in parallel by the other sub-systems (at block 704 and block 706) becomes invalid. There can be a number of criteria regarding the step size. One criteria can be a measure of how much the step size changes the underlying system, such that the step is not too large that invalidates the other sub-systems. One approach can be evaluation of a key vector that is a representation of the KKT system. When the KKT system is updated, how much that key vector changes determines how valid all the other parallel computations are. Optimization that is being executed by the sub-system at block 706, can be measured for accuracy of the optimized preconditioner. As an example, an accuracy threshold can be set, with regards to the step. As an example, a step can be taken such that the preconditioner does not experience more than a 10% accuracy loss.

By doing every component of the algorithm iteratively, and constantly updating each component with the latest best from every other component, the available compute power on massively parallel systems that employ GPUs and/or TPUs (such as the Nvidia DGX-H100 or the NVidia Grace Hopper) can be leveraged to converge more rapidly towards an optimal solution while retaining the generality of the algorithm, since the optimizing preconditioner does not require narrow assumptions about the structure of the model.

In this approach, idle capacity is put to work ensuring that the core loop is not blocked waiting for a preconditioner to be computed and that it is not wasting time finding an extremely high precision solution to an approximation of the original problem.

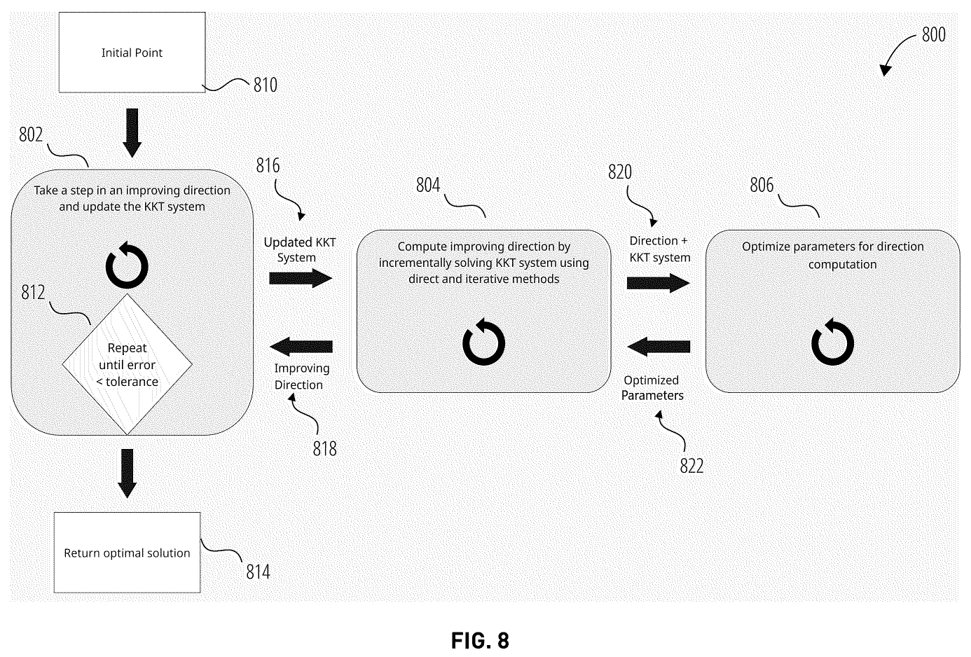

FIG. 8 illustrates a block diagram 800 for solving a convex optimization problem using parallel iterative subsystems. in accordance with one embodiment. FIG. 8 is a generalization of the process illustrated in FIG. 7, by expanding block 706 to cover a broad range of algorithms.

As in FIG. 7, there are three separate core loops, 802, 804 and 806, that are all interacting with each other, as shown by inputs/outputs 816, 818, 820 and 822. FIG. 8 illustrates a way to solve a KKT system in an iterative fashion while simultaneously updating that system. Each of the blocks 802, 804 and 806 represent an iterative sub-system. The circular arrow in each block visually represents the iterative nature of the subsystem. The sub-systems, as represented by blocks 802, 804 and 806, process in parallel. On each iteration, each of the blocks 802, 804 and 806 publish their respective outputs and read the respective latest inputs, as shown by inputs/outputs 816, 818, 820 and 822.

For example, at block 802, the sub-system takes as initial input, an initial point 810. Following input of the initial point 810, at block 802, the sub-system takes as input, a step in an improving direction, while it outputs an update of the KKT system, during an iteration. The sub-system at block 802 that refers to “take a step”, is equivalent to updating the point (with reference to FIG. 2, block 208). In fact, the sub-system at block 802 merges the two disparate blocks of constructing a KKT system (block 204 in FIG. 2) and updating a point (block 208 in FIG. 2) into one. In addition, the sub-system at block 802 evaluates one or more metrics between the updated point and an input point at decision block 812. If the one or more metrics are below a respective tolerance, then the updated point is the optimal solution, and it is returned at block 814. If, on the other hand, each of the respective tolerances is not met, the sub-system at block 802 interacts with the sub-systems at block 804 and 806.

In parallel, the sub-system at block 804 computes improving direction by incrementally solving the updated KKT system using direct and iterative methods. The sub-system at block 804 has two sets of input: an updated KKT system (output 816 from the sub-system at block 802), and optimized parameters (output 822 from the sub-system at block 806). Furthermore, the sub-system at block 804 has two sets of output: an improving direction 818 (which serves as input for the sub-system at block 802), and a direction with an incremental solution of the KKT system 820 (which serves as an input for the sub-system at block 806).

In parallel, the system at block 806 optimizes parameters for direction computation; these can include a preconditioner, matrix permutation, or algorithm meta-parameters. The sub-system at block 806 takes as input, a direction with an incremental solution of the KKT system 820 (which serves as an output for the sub-system at block 804), while it outputs optimized parameters 822 (which serves as an input for the sub-system at block 804), during an iteration.

Inherent in the process illustrated in FIG. 8 is the premise that the step taken in improving the direction is small, in that if too big a step is taken by the sub-system at block 802, then the work performed in parallel by the other sub-systems (at block 804 and block 806) becomes invalid. There can be a number of criteria regarding the step size. One criteria can be a measure of how much the step size changes the underlying system, such that the step is not too large that invalidates the other sub-systems. One approach can be evaluation of a key vector that is a representation of the KKT system. When the KKT system is updated, how much that key vector changes determines how valid all the other parallel computations are.

A small-step criterion can be applied to determine a step size that satisfies a predefined bound on the norm of the update direction, optionally enforced via a line search or trust-region procedure. The predefined bound may be dynamically adjusted based on one or more convergence indicators including at least one of: residual norm of the KKT system, primal-dual gap, or condition number of the system matrix. In addition, the small-step criterion can be enforced using GPU or TPU kernels that may dynamically adjust step size based on convergence indicators computed in parallel. Note that the final step size is determined by a line search mentioned; however to guarantee the step is made using the direction that was used by the line search—not by the latest direction that may have changed since it was being improved in parallel. That is, line search can be used to determine the step size.

By doing every component of the algorithm iteratively, and constantly updating each component with the latest best from every other component, the available compute power on massively parallel systems that employ GPUs and/or TPUs (examples include the NVidia™ DGX-H100 or the NVidia™ Grace Hopper) can be leveraged to converge more rapidly towards an optimal solution while retaining the generality of the algorithm, since the optimizing preconditioner does not require narrow assumptions about the structure of the model.

In this approach, idle capacity is put to work ensuring that the core loop is not blocked waiting for a preconditioner to be computed and that it is not wasting time finding an extremely high precision solution to an approximation of the original problem.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
(a) receive an initial point for the convex optimization problem;
(b) iteratively update an optimization point, by a first iterative subsystem, by:
first constructing and then updating a Karush-Kuhn-Tucker (KKT) system based on a current point, thereby producing an updated KKT system; and
taking a step in an improving direction;
(c) in parallel with step (b):
compute the improving direction, by a second iterative subsystem, by incrementally solving the updated KKT system using one or more direct or iterative methods; and
optimize, by a third iterative subsystem, one or more parameters for direction computation;
(d) exchange outputs among the parallel iterative subsystems during each iteration, wherein:
the updated KKT system is provided to compute the improving direction;
the improving direction is provided to update the optimization point;
an incremental solution of the KKT system is provided to optimize the parameters; and
optimized parameters are provided to compute the improving direction;
(e) apply a small-step criterion to determine a step size that satisfies a predefined bound on a norm of the update direction;
(f) continue iterative updates until one or more convergence criteria are satisfied; and
(g) output an optimal or near-optimal solution to the convex optimization problem.

2. The computing apparatus of claim 1, wherein the one or more parameters include at least one of a preconditioner, a matrix permutation, or algorithm meta-parameters.

3. The computing apparatus of claim 1, wherein the small-step criterion is enforced by a line search or trust-region procedure that ensures monotonic decrease in an objective or merit function.

4. The computing apparatus of claim 3, wherein the predefined bound is dynamically adjusted based on one or more convergence indicators include at least one of: residual norm of the KKT system, primal-dual gap, or condition number of the system matrix.

5. The computing apparatus of claim 3, wherein the small-step criterion is applied in parallel with parameter optimization, such that the step size and preconditioner parameters are jointly tuned to improve convergence.

6. The computing apparatus of claim 1, wherein the iterative subsystems are executed on one or more graphics processing units (GPUs) or one or more tensor processing units (TPUs) configured to perform parallel matrix operations for solving the KKT system.

7. The computing apparatus of claim 6, wherein:
the small-step criterion is enforced using GPU or TPU kernels that dynamically adjust step size based on convergence indicators computed in parallel.

8. The computing apparatus of claim 6, wherein the GPU or TPU execution includes partition the KKT system into blocks and distributing the blocks across multiple processing cores for concurrent computation of the improving direction.

9. A non-transitory computer-readable storage medium, the computer-readable storage medium including instructions that when executed by a computer, cause the computer to:
(h) receive an initial point for the convex optimization problem;
(i) iteratively update an optimization point, by a first iterative subsystem, by:
first constructing and then updating a Karush-Kuhn-Tucker (KKT) system based on a current point, thereby producing an updated KKT system; and
taking a step in an improving direction;
(j) in parallel with step (b):
compute the improving direction, by a second iterative subsystem, by incrementally solving the updated KKT system using one or more direct or iterative methods; and
optimize, by a third iterative subsystem, one or more parameters for direction computation;
(k) exchange outputs among the parallel iterative subsystems during each iteration, wherein:
the updated KKT system is provided to second iterative subsystem compute the improving direction;
the improving direction is provided to the first iterative subsystem update the optimization point;
an incremental solution of the KKT system is provided to the third iterative subsystem optimize the parameters;
optimized parameters are provided to the first iterative subsystem compute the improving direction;
(l) apply a small-step criterion to determine a step size that satisfies a predefined bound on a norm of the update direction;
(m) continue iterative updates until one or more convergence criteria are satisfied; and
(n) output an optimal or near-optimal solution to the convex optimization problem.

10. The non-transitory computer-readable storage medium of claim 9, wherein the one or more parameters include at least one of a preconditioner, a matrix permutation, or algorithm meta-parameters.

11. The non-transitory computer-readable storage medium of claim 9, wherein the small-step criterion is enforced by a line search or trust-region procedure that ensures monotonic decrease in an objective or merit function.

12. The non-transitory computer-readable storage medium of claim 11, wherein the predefined bound is dynamically adjusted based on one or more convergence indicators include at least one of: residual norm of the KKT system, primal-dual gap, or condition number of the system matrix.

13. The non-transitory computer-readable storage medium of claim 11, wherein the small-step criterion is applied in parallel with parameter optimization, such that the step size and preconditioner parameters are jointly tuned to improve convergence.

14. The non-transitory computer-readable storage medium of claim 9, wherein the iterative subsystems are executed on one or more graphics processing units (GPUs) or one or more tensor processing units (TPUs) configured to perform parallel matrix operations for solving the KKT system.

15. The non-transitory computer-readable storage medium of claim 14, wherein:
the small-step criterion is enforced using GPU or TPU kernels that dynamically adjust step size based on convergence indicators computed in parallel.

16. The non-transitory computer-readable storage medium of claim 14, wherein the GPU or TPU execution includes partition the KKT system into blocks and distributing the blocks across multiple processing cores for concurrent computation of the improving direction.

17. A computer-implemented method for solving a convex optimization problem using parallel iterative subsystems, the method comprising:
(o) receiving an initial point for the convex optimization problem;
(p) iteratively updating an optimization point, by a first iterative subsystem, by:
first constructing and then updating a Karush-Kuhn-Tucker (KKT) system based on a current point, thereby producing an updated KKT system; and
taking a step in an improving direction;
(q) in parallel with step (b):
computing the improving direction, by a second iterative subsystem, by incrementally solving the updated KKT system using one or more direct or iterative methods; and
optimizing, by a third iterative subsystem, one or more parameters for direction computation;
(r) exchanging outputs among the parallel iterative subsystems during each iteration, wherein:
the updated KKT system is provided to second iterative subsystem computing the improving direction;
the improving direction is provided to the first iterative subsystem updating the optimization point;
an incremental solution of the KKT system is provided to the third iterative subsystem optimizing the parameters;
optimized parameters are provided to the first iterative subsystem computing the improving direction;
(s) applying a small-step criterion to determine a step size that satisfies a predefined bound on a norm of the update direction;
(t) continuing iterative updates until one or more convergence criteria are satisfied; and
(u) outputting an optimal or near-optimal solution to the convex optimization problem.

18. The computer-implemented method of claim 17, wherein the one or more parameters include at least one of a preconditioner, a matrix permutation, or algorithm meta-parameters.

19. The computer-implemented method of claim 17, wherein the small-step criterion is enforced by a line search or trust-region procedure that ensures monotonic decrease in an objective or merit function.

20. The computer-implemented method of claim 19, wherein the predefined bound is dynamically adjusted based on one or more convergence indicators including at least one of:
residual norm of the KKT system, primal-dual gap, or condition number of the system matrix.

21. The computer-implemented method of claim 19, wherein the small-step criterion is applied in parallel with parameter optimization, such that the step size and preconditioner parameters are jointly tuned to improve convergence.

22. The computer-implemented method of claim 17, wherein the iterative subsystems are executed on one or more graphics processing units (GPUs) or one or more tensor processing units (TPUs) configured to perform parallel matrix operations for solving the KKT system.

23. The computer-implemented method of claim 22, wherein:
the small-step criterion is enforced using GPU or TPU kernels that dynamically adjust step size based on convergence indicators computed in parallel.

24. The computer-implemented method of claim 22, wherein the GPU or TPU execution includes partitioning the KKT system into blocks and distributing the blocks across multiple processing cores for concurrent computation of the improving direction.
